(19) United States
(12) Patent Application Publication
(10) Pub. No.: US 2026/0347077 A1
(43) Pub. Date: Nov. 5, 2026

(54) HIGH PERFORMANCE POLYETHYLENE TAP DISPENSER SPRING BUTTON

(71) Applicant: Liqui-Box Corporation, Richmond, VA (US)

(72) Inventors: Craig F. Knaack, Richmond, VA (US); Derek Ernst, Richmond, VA (US); Eric Gehrke, Richmond, VA (US)

(21) Appl. No.: 19/158,926

(22) PCT Filed: Feb. 22, 2024
(86) PCT No.: PCT/US2024/016937

§ 371 Date: Aug. 22, 2025

Related U.S. Application Data
(60) Provisional application No. 63/448,108, filed on Feb. 24, 2023.

(51) Int. Cl. B65D 77/06; B65D 65/38

(52) U.S. Cl. CPC B65D 77/067; B65D 65/38; B65D 2565/386

(57) ABSTRACT

The disclosure provides a recyclable spring button (150) component of a tap dispenser assembly (110) for use with a fluid container and a mono-material tap dispenser assembly (110) comprising the recyclable spring button (150). The components of the tap dispenser assembly (110) are all constructed from a polymeric mono-material that exhibits excellent storage properties, physical performance when in use, and provides improved sustainability in light of the convenient recyclability of the polymeric monomaterials.

### CROSS REFERENCE TO RELATED APPLICATIONS

This application is related to and claims the benefit of priority to U.S. Provisional Patent Application No. 63/448,108, filed Feb. 24, 2023, which is incorporated herein by reference in its entirety, for all purposes.

### FIELD

The disclosure relates to a polymer resin or polymer resin blend that is useful in constructing various components useful in the packaging and/or dispensing of flowable products (e.g., liquids). More specifically, the polymer resin/resin blend can be used to prepare one or more components of a tap dispenser assembly, and provides for physical performance that is at least as robust as state of the art materials. The polymer resin/resin blend provides improved sustainability as it allows for the packaging and dispensing components to be recycled as a monomaterial that does not require separation of either (i) the dispensing component(s) from the liquid container, or (ii) the component parts of the dispenser components (e.g., tap or spring button) prior to recycling.

### BACKGROUND

Disposable plastic fluid containers are used to hold, ship, store, contain, and dispense a wide variety of liquids. These fluid containers include free-standing rigid containers, flexible containers, or bag in box containers, and are typically constructed to be equipped or fitted with a tap assembly that is used to dispense the liquid product on demand. The tap dispenser assemblies typically include several component parts, including a dispenser body, one or more channels that directs flow of the liquid product, one or more valves (e.g., seal valves and/or seal cups), and a flexible spring button that is used to control the dispensing of the product. While such tap dispenser assemblies are well known in the art, the assemblies are typically constructed from different materials, which are often dictated by the physical requirements of each component parts. For example, the valves, seals, and spring button components, and spring buttons in particular, undergo consistent physical stresses that often require them to be manufactured from non-recyclable materials such as thermoplastic elastomers (TPEs such as, e.g., thermoplastic copolyesters (TPC), thermoplastic polyolefin elastomers (TPO/TPE-o), thermoplastic vulcanizates (TPV), thermoplastic polyurethanes (TPU), thermoplastic polyamides (TPA), styrenic block copolymers (TPS) and the like).

As such, existing tap dispenser assemblies typically include component parts (e.g., spring buttons) that can place a higher demand on resources relative to the other components. For example, from a recycling/sustainability perspective, valves, seals, and spring button component parts may be constructed from materials that can act as a recycling pollutant, requiring it to be separated and sorted from the other tap assembly components prior to recycling. Accordingly, there is a need for tap dispenser assemblies, and spring button components in particular, that are constructed from polymer resin materials that maintain the physical requirements of the component(s), while also improving various aspects associated with manufacturing and sustainability such as, for example, allowing for the recycling of the entirety of the tap assembly along with the fluid container, essentially as a mono-material.

### SUMMARY

In an aspect, the disclosure relates to a mono-material tap dispenser assembly that comprises a spring button component comprising a polymer material (e.g., polymer resin) that has comparable or improved physical performance characteristics relative to existing spring button materials, while also allowing for the spring button to be recycled with the mono-material tap dispenser assembly and/or the fluid container to which the tap dispenser assembly is attached.

In an aspect, the disclosure relates to a spring button component of a tap dispenser assembly that comprises a polymer material (e.g., polymer resin) that has comparable or improved physical performance characteristics relative to existing spring button materials, while also allowing for the spring button to be recycled with the tap dispenser and/or the fluid container to which the tap dispenser assembly is attached.

In some aspects, the disclosure provides a method for preparing a polyolefinic resin blend having one or more physical performance characteristics as generally described herein. In some embodiments, the polyolefinic resin blend is used to prepare a tap dispenser assembly component that is typically made from a thermoplastic elastomer. In some further embodiments, the polyolefinic resin blend is used to prepare a spring button component of a tap dispenser assembly having one or more physical performance characteristics as described herein.

In some aspects, the disclosure provides for the manufacture of a spring button component of a tap dispenser assembly, wherein the spring button component comprises a polyolefinic resin as described herein. In some embodiments, the disclosure provides a method for manufacturing a mono-material tap dispenser assembly comprising a spring button component, as generally described herein.

Additional aspects and embodiments of the disclosure will be apparent to one of ordinary skill in the art in view of the following description and illustrative examples.

### BRIEF DESCRIPTION OF THE DRAWINGS

FIGS. 1A-1C depicts a perspective view an example of a tap dispenser assembly comprising a spring button, in accordance with some non-limiting embodiments of the disclosure. FIG. 1A depicts the assembly in a closed position and with an optional anti-tamper cap installed. FIG. 1B depicts the assembly in a closed position and with the optional anti-tamper cap removed. FIG. 1C depicts the assembly in the open position (i.e., spring button depressed).

### DETAILED DESCRIPTION

Before continuing with the further details regarding the disclosure, it is to be understood that this disclosure is not limited to specific materials (including polymers, copolymers, interpolymers, additives, and the like), structures and arrangements, or process steps and intended or envisioned applications and uses, as such may vary while still falling within the scope of the description provided herein.

The percentages recited in the disclosure typically refer to either percent weight of the total weight of the composition, and are typically denoted when recited. All ratios expressed in this patent application are on a weight:weight basis unless expressed otherwise.

Ranges are used as shorthand only to avoid listing and describing each and every value within the range. Any appropriate value within the range can be selected as the upper value, the lower value, or the end-point of the range.

The singular form of a word includes its plural, and vice versa, unless the context clearly dictates otherwise. Thus, references “a,” “an,” and “the” generally include the plurals of the respective terms they qualify. For example, reference to “a method” includes its plural-“methods.” Similarly, the terms “comprise,” “comprises,” and “comprising,” whether used as a transitional phrase in the claims or otherwise, should be interpreted inclusively rather than exclusively. Likewise, the terms “include,” “including,” “has,” “having,” and “or” should be construed to be inclusive, unless such a construction is clearly prohibited from the context. Similarly, the term “examples,” particularly when followed by a listing of terms, is intended to be merely exemplary, illustrative, and non-limiting and thus should not be deemed to be exclusive or comprehensive.

Unless defined otherwise, all technical and scientific terms, terms of art, and acronyms used in the disclosure have the meanings commonly understood by one of ordinary skill in the art in the relevant technology field(s) in which the term is used. Although any compositions, methods, articles of manufacture, or other means or materials similar or equivalent to those described in the disclosure can be used in the practice of the various aspects and embodiments herein, specific compositions, methods, articles of manufacture, or other means or materials are described only for purposes of illustration and clarity.

All patents, patent applications, publications, technical and/or scholarly articles, and other references cited or referred to herein are incorporated in their entirety by reference to the extent allowed by law. The discussion of those references is intended merely to summarize the assertions made in these references. No admission is made that any such patents, patent applications, publications or references, or any portion thereof, are relevant, material, or prior art to the disclosure or the scope of claims.

As used herein, the term “flowable material” does not include gaseous materials powders or other solid materials, but encompasses any liquid materials which are flowable under gravity or may be pumped. Such materials include liquids (for example, detergents, syrup, mixes, alcohol (e.g., wine, beer, etc.), milk, water, fruit juice, oil, etc.), semi-solid and liquid emulsions (for example, ice cream, ice cream mix, soft margarine, whipping cream, doughs, etc.), and the like. The aspects and embodiments described herein find particular use for detergents or flowable foods and beverages, including those that may be packaged at a range of temperatures (e.g., elevated (“hot-fill”), ambient, and/or refrigerated temperatures).

As used herein “density” is determined by ASTM D 792 and “melt-index” by ASTM D 1238. The “melting point” of a polymer is measured as the peak melting point when performing differential scanning calorimetry (DSC) as described in ASTM Procedure D3417-83 (rev. 88).

In a general sense, the disclosure provides for novel combinations of polyethylene resins that have surprising physical properties allowing for their substitution in the manufacture of one or more tap dispenser assembly components that are typically comprised of or constituted by thermoplastic elastomer materials. In some particular aspects, the polyethylene resins can be used to manufacture seals, valves, and spring buttons components of tap dispenser assemblies or other similar dispensing valves or dispensing fitments. The assembly components comprising the polyethylene resins in accordance with the disclosure typically retain the physical performance characteristics and requirements of those components made from the current state of the art materials, typically thermoplastic elastomers, but allow for such assemblies to be recycled as mono-materials.

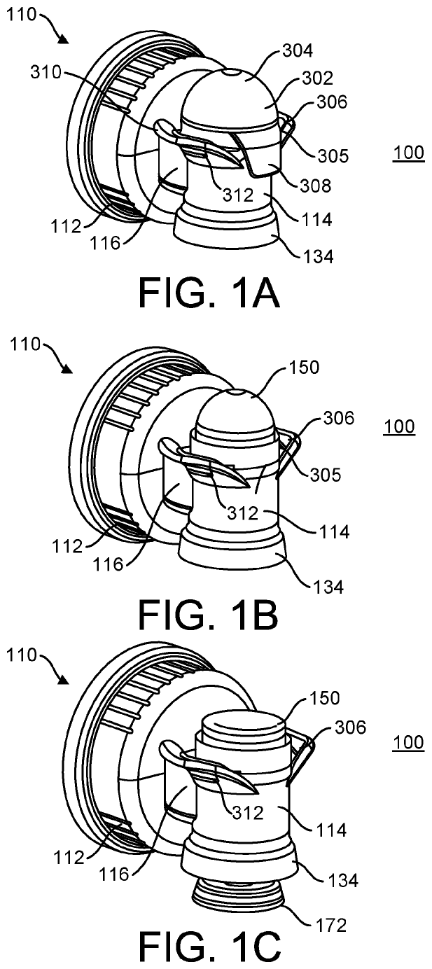

FIG. 1 provides a general illustrative overview of the various components of an example tap dispenser assembly 100. The tap assembly includes an attachment portion 112, a dispensing portion 114, and a channel portion 116, which together constitute the tap body 110. The attachment portion 112 is configured to connect to a spout of an associated fluid container. The attachment portion 112 may include internal threads to correspond with external threads of the container spout. The attachment portion 112 also includes a sealing surface on its interior that creates a seal between the tap body 110 and the container spout when the dispenser assembly 100 is attached to the container. The channel portion 116 has a plurality of walls (e.g., upper, lower, and side walls) that define a fluid flow passage that fluidly connects the attachment portion 112 with the dispensing portion 114.

The dispensing portion 114 houses the spring button 150 and the valve. The dispensing portion 114 includes a button attachment groove for receiving a portion of the spring button 150. The dispensing portion 114 also includes a sealing surface. The spring button 150 has a domed flexible region, and within the tap body 110, a stem receiving portion, and a sealing portion. The sealing portion is installed into the button attachment groove. Once installed, the sealing portion secures the spring button to the tap body 110 and creates a fluid seal between the spring button 150 and the tap body 110. The stem receiving portion forms a stem opening. The spring button 150 is constructed from the resins in accordance the aspects and embodiments of the disclosure.

In some embodiments, the tap dispenser assembly 100 further includes an anti-tamper cap 302. The anti-tamper cap 302 includes a domed cover portion 304, two locking tabs 306, and a removal tab 308. The cover portion 304 is made of a rigid plastic. The locking tabs 306 are connected to the cover portion 304 by a scored surface 305.

When installed as in FIG. 1A, the cover portion 304 covers the spring button 150 and prevents the spring button 150 from being depressed. The dispensing portion 114 includes two finger supports 310 on either side of the dispensing portion 114. The finger supports 310 provide a location for a user to grip and provide a counter force while the user depresses the spring button 150 during the dispensing of fluid. As illustrated, the finger supports 310 are curved and angled upward to be more comfortable and ergonomic during use as compared to previous designs that were flat and extended horizontally from the tap body. When supplied with an anti-tamper cap 302, the finger supports 310 may include locking holes 312. Each locking hole 312 receives a corresponding locking tab 306 of the anti-tamper cap 302. The locking tabs 306 are secured within the locking holes 312 with a snap fit connection, an adhesive, by sonically welding the components together, and/or other similar form of attaching the components to prevent the locking tab 306 from subsequent removal from the locking holes 312. The removal tab 308 extends from the cover portion 304.

FIG. 1B depicts the assembly 100 in the closed position, where the removal tab 308 has been used to remove the protective cover portion 304. The cover portion 304 separates from, i.e., breaks off of, the locking tabs 306 along the scored surface 305, thereby exposing the spring button 150. The locking tabs 306 remain within the locking holes 312 and provide an indication to users that the cover portion 304 of the tamper evident cap 302 has been removed.

FIG. 1C shows the tap dispenser assembly 100 in the open position with the spring button 150 pressed down and the interior of the valve body 172 extending below the protective shroud 134. The locking tabs 306 within the locking holes 312 do not affect the ability of the tap dispenser assembly 100 to move to the open position once the cover portion 304 is removed.

In some embodiments, a spring button and/or a tap dispenser assembly comprising the spring button finds use in combination with a flexible bag or rigid container that comprises a flowable material to be dispensed. In embodiments comprising a bag, the bag may be packed in a relatively rigid container, e.g., a corrugated cardboard box, for distribution (e.g., a “bag-in-box”). Typically in any such embodiments, at the point of use (e.g., point of connection with the assembly), a spout or fitment on the flexible bag or container is adapted to mate the dispensing tap assembly or, optionally to a service line connector, which is, at a point downstream in the line, configured to be fitted to the dispensing tap assembly, allowing for the control and direct dispensing of the contents. In some embodiments, larger capacity containers, and bags in particular, are suitable for use in combination with additional support materials such as, for example, wooden bins, metal, plastic, or corrugated totes, drums, and the like.

In some embodiments, additional dispensing aids that are known in the art such as evacuation channels, tubes, forms, dip strips or reinforced/embossed films that can incorporated in order to aid with complete evacuation of the contents. In some embodiments, a spout can be adapted for use with the tap dispenser assembly described herein by comprising a quick-connect/disconnect fitting and/or valve. Such quick-connect/disconnect fittings and valves can comprise a valve element that slides within the fitment or spout, projecting into the container or bag when actuated by the insertion of a tap dispenser assembly (or service line connector) and being withdrawn within the fitment to cut off the flow of contents when the assembly or connector is withdrawn.

In use, the tap dispenser assembly in accordance with example embodiments of the disclosure are able to achieve evacuation of the flowable materials/contents of a bag or rigid container to levels that are in line with industry demands (i.e., evacuation of 95% or more of the contents (e.g. 95% or more, 96% or more, 97% or more, 98% or more, 99% or more, 99.5% or more, 99.6% or more, 99.7% or more, 99.8% or more, 99.9 or more %)). In use, the tap dispenser assembly provides for the evacuation of the flowable contents of a container to be achieved in any variety of configurations and container types, such as rigid packaging/containers, flexible bags, and/or bag-in-boxes, and can be configured for dispensing in orientations such as, for example, with the dispensing spout bottom-facing as well as in side-facing arrangements.

Thus, in accordance with some embodiments, a tap dispenser assembly may be adapted to interact (e.g., securely engage either permanently or temporarily) with a fitment or spout, or other known type of opening or access point, that is attached to a container holding a flowable product or material. The engagement between the tap dispenser assembly and the opening typically forms a liquid tight seal. In example embodiments the container may be a flexible bag made from one or more plastic materials or a semi-rigid container, also of a plastic material, that holds the flowable product or material (e.g., liquids or semi-solids) that are to be dispensed. The tap dispenser assembly in accordance with example embodiments of the disclosure can be adapted and sized according to the size of the fitment, spout, opening, or access point, as well as to the volume, size, and/or shape of the bag or container so that a desired level of flow through the probe can be achieved. A wide variety of liquids or semi-solids can be dispensed through the probe including, for example, viscous, but flowable, (liquid) foods, for example, coffee, soda, milk, cooking oil, syrups, alcohol (e.g., wine, beer), water, drink mixes, as well as flowable (liquid) chemicals such as, for example, detergents, cleaning liquids, hand soap, pastes, and adhesives/glues.

In some aspects and embodiments, the spring button and/or one or more components of the tap dispenser assembly may be formed by casting, molding (e.g., injection molded) or 3D printing from a variety of polyethylene materials as discussed herein. In some embodiments, a tap dispenser assembly generally comprises a hollow, cylindrical body having a structure (e.g., nipple, threads, protrusions, spout, etc.) capable of mating with other dispensing members (e.g., a tube, hose, lead-in line, or other opening configured to receive product). The tap dispenser assembly may also comprise any number of additional features including, for example, one or more flanges that may extend around at least a portion of the circumference of the tap dispenser assembly. As discussed above, the tap dispenser assembly typically comprises an external surface adapted or configured to mate (e.g., frictional, secured fit) with a fitment, spout or other access point to the container. When the spring button is actuated for use, product flows through the tap dispenser assembly when it is securely fit to the packaging as described herein and as generally known in the art (e.g., to a fitment and penetrating any seal or cap in the packaging).

As noted above, one or more components, in addition to the spring button, of the tap dispenser assemblies can comprise the resins described herein. For example, some embodiments provide for seals, valves, and/or seal cups that are typically constructed with thermoplastic materials (e.g., thermoplastic elastomers, thermoplastic copolyesters, etc.), to instead be constructed from the polyethylene resin materials in accordance with the disclosure.

The spring button in accordance with the disclosure can be designed to have any dimension that may be useful in a particular application, and as generally known in the art. For example, in some embodiments, a spring button may have an outer diameter that ranges from about an inch or more, to about 0.5 or 0.75 inches. Typically, the spring button is designed for ease of use, or comfort of use, to be depressed and used by a human-sized finger or thumb (e.g., adult, teen, or young child (e.g., 5 years or older). The variability of the spring button diameter can create a difference in the upward force it applies when in the fully open position (i.e., greater force is associate with larger diameter), which additional force typically compensates for the larger sealing surface diameter that is typically associated with a larger diameter spring button. Similarly the height of the spring button can vary widely and within the typical designs that constitute the state of the art (e.g., from about 0.5 inches tall to about 0.75 inches tall).

As discussed above, the spring button component of the state of the art tap dispenser assemblies are typically made from a thermoplastic elastomer (TPE) material such as thermoplastic copolyesters or other block copolymers (e.g., Arnitel®, Hytrel®, among others). While those materials have properties that are favorable for spring button applications, such as ability to recover original shape after being stretched or elongated, good rebound/elastic recovery, high melt temperatures, high density and absence of significant cold flow deformation (creep), the raw materials can be costly relative to common polyethylene polymers, and are typically considered as a pollutant with regard to recyclability. As discussed below, the polyethylene resin materials described herein address these disadvantages, while also surprisingly providing for physical performance characteristics that are comparable to, or better than, the state of the art TPEs.

In embodiments of the aspect relating to the spring button described herein, the spring button is constructed from one or a combination of polyethylene resins. In some embodiments, the one or combination of resins comprises a density that allows for flexibility and performance of the material that is similar to the flexibility and performance of a typical state of the art thermoplastic elastomer (TPE) material. In some preferred embodiments, the resin material comprises a combination of two or more resins. The physical performance characteristics (e.g., flexibility, softness, depression force, etc.) of the resins can be measured by any one or more tests or assays including, for example, those that measure environmental stress crack resistance (ESCR, e.g., by ASTM 1693); stiffness; flexibility; deformability; elastic recovery (e.g., material rebound as a function of time); depression force; flexural modulus; ability to form/reform seal, etc., any of which can be measured relative to the state of the art TPE material (e.g., Arnitel® (DSM), Hytrel® (Celanese), etc.). In embodiments the resins, when formed into a tap dispenser component (e.g., a spring button as exemplified herein), have physical performance characteristics that are comparable and/or improved relative to the state of the art TPE material. Additional characteristics of the resin material can include oxygen transmission rate (OTR), flex-crack resistance (FCR), and differential scanning calorimetry (DSC), and porosity, among other characteristics.

In some embodiments, a spring button component comprising the resin material of the disclosure has good elastic recovery (or button rebound) when compared to a spring button component having the same general geometry, but formed from the state of the art materials. In such embodiments, the elastic recovery of a spring button in accordance with the disclosure (as measured by the time required for the spring button to return to original position after the release of an applied force adequate to depress the button from original position) falls within a range of milliseconds to about 1 second (i.e., is 1 second or less). In some embodiments, the elastic recovery of a spring button is essentially instantaneous upon release of an applied force that is adequate to depress the spring button.

In some embodiments, a spring button component comprising the resin material of the disclosure has a dome depression force within a range of about 28 N to about 40 N, or about 30 N to about 38 N. In some embodiments a spring button component has a dome depression force of about 30 N, 31 N, 32 N, 33 N, 34 N, 35 N, 36 N, 37 N, or about 38 N. In yet further embodiments, a spring button component has a dome depression force of about 33 N, 34 N, 35 N, 36 N, or 37 N.

In any of these embodiments the resin (one resin or in some preferred embodiments a combination of two or more resins) comprises a density that falls within a range of from about 0.860 g/cm3 to about 0.912 g/cm³, (e.g., inclusive of about 0.860, 0.861, 0.862, 0.863, 0.864, 0.865, 0.866, 0.867, 0.868, 0.869, 0.900, 0.901, 0.902, 0.903, 0.904, 0.905, 0.906, 0.907, 0.908, 0.909, 0.910, 0.911, and about 0.912 g/cm³). In some embodiments the one or combination of two or more resins comprises a density within a range of about 0.865 g/cm3 or about 0.870 g/cm3 to about 0.905 g/cm3.

In some embodiments relating to combinations of different resins, the weight percent of a resin may constitute from about 10% to about 90% of the resin combination (e.g., 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90%). In some preferred embodiments, the weight percent of a resin in a combination may constitute from about 25% to about 75% of the resin combination, about 30% to about 70% of the resin combination, about 35% to about 65% of the resin combination, about 40% to about 60% of the resin combination, about 45% to about 55% of the resin combination, or about 50% of the resin combination. In related embodiments wherein the resin comprises two different resins, the ratio of one resin to the other may vary between about 1:9 and about 9:1 (e.g., about 1:9, 1:8, 1:7, 1:6, 2:9, 1:5, 1:4, 2:7, 1:3, 2:5, 1:2, 2:3, 1:1, 3:2, 2:1, 5:1, 3:1, 7:2, 4:1, 5:1, 9:2, 6:1, 7:1, 8:1, or 9:1).

### Resins

A variety of recyclable polymers and plastomers can be used to produce the spring buttons in accordance with the disclosure. Some embodiments of suitable resins include ethylene/α-olefin (EAO) copolymers that may comprise, for example, ethylene-C4 to C10-α-olefin interpolymer (copolymer). In some embodiments, the ethylene-C4 to C10-α-olefin interpolymer (EAO copolymer) can have a density of from 0.890 to about 0.930 g/cm3 (e.g., including particular values and narrower ranges falling within that range such as, for example, 0.912 g/cm³-0.925 g/cm3; 0.910 g/cm3, 0.911 g/cm3, 0.912 g/cm3, 0.913 g/cm3, 0.914 g/cm3, 0.915 g/cm3, 0.916 g/cm3, 0.917 g/cm3, 0.918 g/cm³, etc.) and may be a single interpolymer or a blend of two or more interpolymers, an interpolymer and one or more copolymers, or an interpolymer and several different individual polymer grades.

The EAO interpolymer may be selected from low-density polyethylenes (LDPEs), conventional Ziegler Natta catalyzed linear low-density polyethylenes (LLDPEs) and metallocene-derived LDPEs, LLDPEs, and VLDPEs (mLDPE, mLLDPE, mVLDPE). According to some conventional industry descriptions, linear low-density polyethylenes in the density range 0.915-0.930 g/cm3 may be referred to as LLDPEs, and those in the density range of 0.900-0.915 g/cm3 may be referred to as ultra-low-density polyethylenes (ULDPEs) or very low-density polyethylenes (VLDPEs).

Other example embodiments of suitable polymers and plastomers that may be used in various embodiments of the spring button resin blends are commercially available and sold under various tradenames and trademarks including, for example ExxonMobil Chemical (e.g., polyethylenes and performance PE polymers (EXACT™, EXCEED™ XP, EXCEED™, ENABLE™, EXXONMOBIL™ LDPEs, NEXXSTAR™ LDPE, EXXONMOBIL™ LLDPES, EXXONMOBIL™ NTX LLDPE)) and Dow Chemical (e.g., polyethylenes (ENGAGE™, AFFINITY™, AGILITY™, ASPUN™, DOW™ LDPEs, DOWLEX™, ELITE™, INNATE™ XUS 59999.38)) as well as other commercial sources. The particular interpolymer(s) and/or polymer(s) may be selected based on particular performance characteristics as described herein (e.g., density, melt index, etc.). Some non-limiting examples of suitable resins include polyolefinic elastomers that are based on or comprise an ethylene-octene, ethylene-hexene, and/or ethylene-butene based copolymer, such as resins produced by Exxon Mobile (e.g., the EXACT™ line of resins) or Dow (e.g., the ENGAGE™ line of resins). In some preferred embodiments the resin or combination of resins comprises one or more of EXACT 3040, ENGAGE 8401, ENGAGE 8402, or ENGAGE 8450.

### Additives

In some embodiments, the resins used to form the spring button may comprise standard additives generally known and used in the art including, for example, antioxidants, stabilizers, anti-block agents, and slip additives. Optionally, the resins may comprise one or more additives that may facilitate the processing and manufacturing of a spring button by injection molding methods. Any of such additives that are generally known and find use in the art can be used, including additives of the types that follow.

### Slip Agents

Any slip agent known in the art may be included in the resins, typically in a range from about 200 to 2000 ppm or 0.5-2.5% by weight. In some embodiments a slip agent may be added in less that about 200 ppm (even to none, i.e., 0 ppm) if an anti-blocking agent is added in amounts that provide some function that would be provided by addition of one or more slip agent(s). Non-limiting examples of a slip agent include erucamide or other fatty acid amides, such as oleamide, and inorganic agents such as high molecular weight polysiloxanes. The slip agent may lower the coefficient of friction to allow the spring button to interact more smoothly with other components of the tap dispenser assembly.

### Anti-Blocking Agents

Any anti-blocking agent known in the art may be added to the resins, typically in the range of about 1000-5000 ppm or 0.5-2.5% by weight. However, in some embodiments the amount of anti-blocking agent(s) can be increased to about 10,000 ppm without having any negative impact on the properties and performance characteristics of the spring button. For example, typical anti-blocking agents, such as diatomaceous earth, synthetic silica or talc, can be added. The anti-blocking material may help reduce the coefficient of friction between the spring button and other surfaces of the tap dispenser assembly, helping to reduce wear during use.

### Processing Aids

Any processing aid known in the art, such as the non-limiting example of a fluoro-elastomer based polymer may be added to the resin(s).

In some embodiments the disclosure provides a process for making a spring button comprising the resins described herein, using conventional processes, such as injection molding. Such methods of manufacturing are generally known in the art and can be used in accordance with the resins, spring buttons, and tap dispenser assemblies generally described herein.

The examples that follow will help to provide further illustration and clarity to the disclosure and the aspects and embodiments described above.

### EXAMPLES

The Examples illustrate embodiments of the disclosure, including experimental test data directed to the tap dispenser assembly and the performance of illustrative spring buttons comprising the resins described herein, and relative to materials that represent the state of the art. As described below, spring buttons in accordance with the embodiments described herein demonstrate physical performance characteristics within target parameters and in line with state of the art materials, and are expected to perform within industry standards required for longevity (e.g., crack resistance, storage stability, flex modulus/form retentions), force required to operate, and provide for adequate flow rates for dispensed liquid products.

### Example 1: Spring Button Manufacture and Performance

This example details a number of trials that prepared molded spring buttons using a variety of resins in accordance with the disclosure. The resulting buttons were tested for physical performance to determine if they fell within acceptable tolerances, including retention of physical features of length (target 0.67 in., range 0.683-0.658 in.) and diameter (target 0.78 in., range 0.789-0.775 in.), dome depression force (target 35 N, range 45-28 N), and valve retention (target 45 N, range 60-35.6 N).

A first series of molded spring buttons were prepared using ENGAGE 8402 resin (Dow) with 8% ampacet slip to aid in mold release and protection of the internal retention feature. During testing of its physical attributes, the material had an average valve retention of 53.5 N, which is well within the target range of 60-35.6 N. The material, however, while within tolerances, was determined to be firm for dome depression (43.3 N of force), when compared to current state of the art Arnitel material (38.3 N).

A subsequent series of molded spring buttons was prepared using 100% ENGAGE 8401 resin (Dow). During testing of its physical attributes, the resulting material was determined to be very soft and difficult to mold, with an inability to keep consistent press permitters during individual tests. The material provided for good rebound timing but had a high rate of leak test failures, especially at elevated temperature (120 °F, according to a Heated Leak Test as discussed below).

Another series of molded spring buttons was prepared using a hand-blended mixture (50/50) ENGAGE 8402 and ENGAGE 8401 resins, each previously individually tested (above). While the molding exhibited inconsistences from shot to shot, the testing of its physical attributes showed the material to be softer than state of the art material (Arnitel), but within acceptable force and retention tolerances.

Another series of molded spring button was prepared using ENGAGE 8450 (Dow), which is characterized as having material properties between those of ENGAGE resins 8402 & 8401 (above). During testing of its physical attributes in a dome depression test, the resulting material was determined to be firm for dome depression (i.e., similar to force required for 8402, above) when compared to current state of the art Arnitel material.

In another series of tests using different resins, a series of molded spring buttons was prepared using an EXACT 3040 resin (Exxon Mobil) (100%). During testing of its physical attributes, the resulting material was determined to have excellent stability while molding, and no issues with retention feature protection, scoring an average valve retention of 51.6 N (well within the target range of 60-35.6 N). Much like several of the Dow resins that were tested, this material was very firm in dome depression, requiring 44 N of force, when compared to current state of the art Arnitel material (38.3 N).

A subsequent series of molded spring buttons was prepared using a mixture of EXACT 3040 (70%) and Dow ENGAGE 8401 (30%). This blend was easily molded with a target 12 second cycle time. During initial testing of its physical attributes, the material had good retention feature protection (length and diameter dimensions) and dome depression and valve retention forces. The material was further processed in additional formulations that incorporated colorant (Riverdale color) and slip aid (at 6000 ppm, for anti-stat) and assessed for dome depression forces (28.7-32.8 N), which were directly comparable to the state of the art Arnitel material (29.9 N).

As may be expected, all the molded spring buttons constructed in accordance with the aspects and embodiments of the disclosure (i.e., using polyethylene resins) were substantially lighter (average weight of 1.25 or 1.24 g/button) than the weight of the state of the art buttons (average weight 1.58 g/button) made from TPE (i.e., Arnitel).

### Example 2: Spring Button Product Compatibility, Accelerated Aging, & Heated Leak Test

Containers (bags) were prepared and fitted with tap assemblies that were prepared with flexible spring buttons constructed from standard materials (control) as well as the materials described in Example 1. The bag were filled with laundry detergent and placed in an oven at 120 °F for a period of time ranging from 24 hours to 15 days. During the test period, functional tests of the spring button performance were conducted several times a day to check for mis-functioning and leakage/seepage. While the feel of the spring button materials felt different when depressed, as the data in Table 1 illustrates, none of the buttons developed a leak and all buttons continued to function throughout the duration of the test.

TABLE 1

| Button | | 24 | 48 | 72 | 1 | 15 |
|---|---|---|---|---|---|---|
| Material | Product | hr | hr | hr | week | days |
| Dow 8402 | detergent | pass | pass | pass | pass | pass |
| Exxon 3040 | detergent | pass | pass | pass | pass | pass |
| Control | detergent | pass | pass | pass | pass | pass |
| Dow 8401 | detergent | pass | pass | pass | pass | pass |
| 75% 3040 | detergent | pass | pass | pass | pass | pass |
| 25% 8401 | | | | | | |
| 75% 3040 | detergent | pass | pass | pass | pass | pass |
| 25% 8401 | | | | | | |

Heated leak tests were conducted on the ENGAGE resins (100% 8401, 100% 8402, 50/50 8401/8402) and the EXACT resin 3040 (100%) and compared to Arnitel. Briefly, the spring buttons were assembled in tap dispensers having a polypropylene body and HDPE valve. The tap assemblies were heated to 120 °F for a period of 72 hr. Separate tap assemblies were cooled to 0 °F for a period of 72 hr. The button materials were tested at 0 hr, 24 hr, 38 hr, and 72 hrs into the testing for leak failures. The results showed that the 100% 8401 resin had failures as early as 24 hrs into the testing for both heat and cold, while the other test resins and control materials were resistant to leaks for the duration of the tests.

Conclusions. While the tested resin materials in amounts up to 100% were capable of being molded and prepared as spring buttons having acceptable physical tolerances, the results tend to show that a blend of two polyethylene resins having base physical characteristics that fall within the scope of the disclosure (e.g., up to 50/50 mixtures of EXACT 3040 and ENGAGE 8401 or 8402) provide improved stability that allow for consistent molding of the material, without high variability shot to shot. These combination resins resulted in spring buttons that had physical characteristics that were directly comparable or improved relative to the state of the art material (i.e., Arnitel® or other thermoplastic elastomers (TPE)). The resin combinations exhibited good dome depression applied forces, performed well in environmental stress crack resistance (ESCR) testing, had good depression rebound time (similar to the state of the art TPE materials), were dimensionally sound (i.e., retained shape), performing as well as the state of the art TPE, but with the inherent advantage of being recyclable with the entirety of the tap assembly and/or the flexible container (i.e., as a mono-material).

It will be understood by those skilled in the art that various changes may be made and equivalents may be substituted without departing from the scope of the various aspects and embodiments of the disclosure. In addition, many modifications may be made to adapt a particular mode, method, or material to the aspects and embodiments of the disclosure without departing from its scope.

1. A recyclable spring button component of a mono-material tap dispenser assembly, wherein the spring button comprises a polyethylene polymer having a density range of about 0.865 g/cm3 to about 0.905 g/cm³, and which has a dome depression force ranging from about 28 N to about 45 N.

2. The recyclable spring button of claim 1, wherein the spring button has an elastic recovery of less than 1 second.

3. The recyclable spring button of claim 1, wherein the polyethylene polymer comprises an ethylene-based hexene copolymer, ethylene-based butene resin, an ethylene-based octene copolymer, or ethylene-based plastomer resin.

4. The recyclable spring button of claim 1, wherein the polyethylene polymer comprises a combination of an ethylene-based hexene copolymer and an ethylene-based octene copolymer.

5. The recyclable spring button of claim 4, wherein the ethylene-based hexene copolymer has a density of about 0.89 g/cm³ to about 0.91 g/g/cm³, and the ethylene-based octene copolymer has a density of about 0.865 g/cm³ to about 0.89 g/cm³.

6. The recyclable spring button of claim 5, wherein the weight percent of the ethylenebased hexene copolymer is from about 60% to 80% of the total weight of the combined polymer.

7. The recyclable spring button of claim 6, wherein the weight percent of the ethylenebased hexene copolymer is from about 70% to 75% of the total weight of the combined polymer.

8. The recyclable spring button of claim 6, wherein the weight percent of the ethylenebased hexene copolymer is about 70% of the total weight of the combined polymer.

9. A mono-material tap dispenser assembly comprising a recyclable spring button component, wherein the spring button comprises a polyethylene polymer having a density range of about 0.8650 g/cm³ to about 0.905 g/cm³, and which has a dome depression force ranging from about 28 N to about 45 N.

10. The mono-material tap dispenser assembly of claim 9, wherein the recyclable spring button has an elastic recovery of less than 1 second.

11. The mono-material tap dispenser assembly of claim 9, wherein the recyclable spring button comprises an ethylene-based hexene copolymer, ethylene-based plastomer resin, an ethylene-based octene copolymer, or ethylene-based butene resin, or combinations thereof.

12. The mono-material tap dispenser assembly of claim 9, wherein the recyclable spring button comprises a combination of an ethylene-based hexene copolymer and an ethylene-based octene copolymer.

13. The mono-material tap dispenser assembly of claim 12, wherein the ethylene-based hexene copolymer in the recyclable spring button has a density of about 0.89 g/cm³ to about 0.91 g/cm³, and the ethylene-based octene copolymer in the recyclable spring button has a density of about 0.865 g/cm³ to about 0.89 g/cm³.

14. The mono-material tap dispenser assembly of claim 12, wherein the weight percent of the ethylene-based hexene copolymer in the recyclable spring button is from about 60% to 80% of the total weight of the combined polymer.

15. The mono-material tap dispenser assembly of claim 14, wherein the weight percent of the ethylene-based hexene copolymer in the recyclable spring button is from about 70% to 75% of the total weight of the combined polymer.

16. The mono-material tap dispenser assembly of claim 15, wherein the weight percent of the ethylene-based hexene copolymer in the recyclable spring button is about 70% of the total weight of the combined polymer.
